(19) United States
(12) Patent Application Publication
(10) Pub. No.: US 2023/0203317 A1
(43) Pub. Date: Jun. 29, 2023

(54) AQUEOUS COATING COMPOSITION AND PROCESS FOR PREPARING THE SAME

(71) Applicants: Dow Global Technologies LLC, Midland, MI (US); Dow Silicones Corporation, Midland, MI (US); Rohm and Haas Company, Collegeville, PA (US)

(72) Inventors: Jinfei Wang, Shanghai (CN); Xiaohong Yang, Shanghai (CN); Tao Wang, Shanghai (CN); Li Zhou, Shanghai (CN); Lili Shi, Shanghai (CN); Zhonghua Zhang, Shanghai (CN); Dong Yun, Shanghai (CN)

(21) Appl. No.: 17/919,693

(22) PCT Filed: May 25, 2020
(86) PCT No.: PCT/CN2020/092063

§ 371 Date: Oct. 18, 2022

(51) Int. Cl. C09D 4/06; C09D 133/06; C09D 7/61; C09D 7/40

(52) U.S. Cl. CPC C09D 4/06; C09D 133/064; C09D 7/61; C09D 7/69

(57) ABSTRACT

An aqueous coating composition comprising (a) from 12.5% to 87% by weight based on the weight of the aqueous coating composition, of a film-forming polymer; (b) from 9.5% to 85% by weight based on the weight of the film-forming polymer, of a specific oligomer; and (c) from 2.5% to 50% by weight based on the weight of the film-forming polymer, of beads with a mean particle size of from 5.0 to 10.5 μm; and a process for preparing the aqueous coating composition.

### FIELD OF THE INVENTION

The present invention relates to an aqueous coating composition and a process for preparing the same.

### INTRODUCTION

Aqueous or waterborne coating compositions are widely used in industrial and architectural applications as they contribute volatile organic compounds (VOCs) as compared to solvent-borne coatings. However, waterborne coatings have found limited acceptance in the wood finishing industry due to a phenomenon referred to in the art as “grain raising”. Wood fibers in the surface of the wood absorb water and swell upon application of waterborne coating compositions. Thereafter, the wood fibers shrink as they dry resulting in wrinkles and/or roughness in the finished wood surface. This problem is exacerbated by the fact that fibers in one area of a wood surface can have different swelling properties than others, leading to varying degrees of surface roughness on any given finished surface. Loosened wood fibers can also protrude upward after absorbing water. When water evaporates from the wood fibers remain in their upright position, sanding is not able to completely remove the raised grain. Two-component waterborne polyurethane coating compositions can be used to improve anti-grain raising performance, but they have shorter pot life and more complicated handling problems as compared to one-component waterborne coating compositions. Moreover, sandability is another essential property for some coating applications such as primers to meet industry requirements.

Therefore, there remains a need to provide a one-component aqueous coating composition that is able to suppress grain raising of wood offering coatings made therefrom with anti-grain raising performance and good sandability suitable for primer applications.

### SUMMARY OF THE INVENTION

The present invention provides an aqueous coating composition that is a novel combination of a specific oligomer and beads with a film-forming polymer. The aqueous coating composition of the present invention can provide coatings with anti-grain raising performance as indicated by an anti-grain raising level of 4 or more and good sandability with rating of 3 or more. These properties may be measured according to the test methods described in the Examples section below.

In a first aspect, the present invention provides an aqueous coating composition comprising:

(a) from 12.5% to 87% by weight based on the weight of the aqueous coating composition, of a film-forming polymer;

(b) from 9.5% to 85% by weight based on the weight of the film-forming polymer, of an oligomer having a number average molecular weight of 9,500 g/mol or less, wherein the oligomer comprises, by weight based on the weight of the oligomer, from 1% to 20% of structural units of an acid monomer, a salt thereof, or mixtures thereof, from 30% to 99% of structural units of a hydrophilic monoethylenically unsaturated nonionic monomer, from 0 to 30% of structural units of a hydrophobic monoethylenically unsaturated nonionic monomer, and from 0 to 20% of structural units of a monoethylenically unsaturated functional monomer; and

(c) from 2.5% to 50% by weight based on the weight of the film-forming polymer, of beads with a mean particle size of from 5.0 to 10.5 μm.

In a second aspect, the present invention provides a process for preparing the aqueous coating composition of the first aspect. The process comprises: admixing (a) from 12.5% to 87% by weight based on the weight of the aqueous coating composition, of a film-forming polymer; (b) from 9.5% to 85% by weight based on the weight of the film-forming polymer, of an oligomer having a number average molecular weight of 9,500 g/mol or less, and (c) from 2.5% to 50% by weight based on the weight of the film-forming polymer, of beads with a mean particle size of from 5.0 to 10.5 μm;

wherein the oligomer comprises, by weight based on the weight of the oligomer,

from 1% to 20% of structural units of an acid monomer, a salt thereof, or mixtures thereof,

from 30% to 99% of structural units of a hydrophilic monoethylenically unsaturated nonionic monomer,

from 0 to 30% of structural units of a hydrophobic monoethylenically unsaturated nonionic monomer, and

from 0 to 20% of structural units of a monoethylenically unsaturated functional monomer.

### DETAILED DESCRIPTION OF THE INVENTION

“Aqueous” composition or dispersion herein means that particles dispersed in an aqueous medium. By “aqueous medium” herein is meant water and from 0 to 30%, by weight based on the weight of the medium, of water-miscible compound(s) such as, for example, alcohols, glycols, glycol ethers, glycol esters, or mixtures thereof.

“Structural units”, also known as “polymerized units”, of the named monomer, refers to the remnant of the monomer after polymerization, that is, polymerized monomer or the monomer in polymerized form. For example, a structural unit of methyl methacrylate is as illustrated:

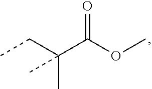

where the dotted lines represent the points of attachment of the structural unit to the polymer backbone.

“Acrylic polymer” or “polyacrylic” herein refers to a homopolymer of an acrylic monomer or a copolymer of an acrylic monomer with a different acrylic monomer or other monomers such as styrene. “Acrylic monomer” as used herein includes (meth)acrylic acid, alkyl (meth)acrylate, (meth)acrylamide, (meth)acrylonitrile and their modified forms such as hydroxyalkyl (meth)acrylate. Throughout this document, the word fragment “(meth)acryl” refers to both “methacryl” and “acryl”. For example, (meth)acrylic acid refers to both methacrylic acid and acrylic acid, and methyl (meth)acrylate refers to both methyl methacrylate and methyl acrylate.

The aqueous coating composition of the present invention comprises one or more oligomers. The oligomers useful in the present invention may comprise structural units of one or more acid monomers, salts thereof, or mixtures thereof. The aid monomer and salt thereof may include, for example, carboxylic acid monomers, sulfonic acid monomers, phosphorous-containing acid monomers, salts thereof, or mixtures thereof. The carboxylic acid monomers can be α, β-ethylenically unsaturated carboxylic acids, monomers bearing an acid-forming group which yields or is subsequently convertible to, such an acid group (such as anhydride, (meth)acrylic anhydride, or maleic anhydride); or mixtures thereof. Specific examples of carboxylic acid monomers include acrylic acid, methacrylic acid, maleic acid, itaconic acid, crotonic acid, fumaric acid, 2-carboxyethyl acrylate, or mixtures thereof. Examples of suitable phosphorous-containing acid monomers and salts thereof include phosphoalkyl (meth)acrylates such as phosphoethyl (meth)acrylate, phosphopropyl (meth)acrylate, phosphobutyl (meth)acrylate, salts thereof, and mixtures thereof; CH₂═C(R₁)—C(O)—O—(R₂O)_{q}—P(O)(OH)₂, wherein R₁═H or CH₃, R₂=alkylene, such as an ethylene group, a propylene group, a butylene group, or a combination thereof; and q=1-20, such as SIPOMER PAM-100, SIPOMER PAM-200, SIPOMER PAM-300, SIPOMER PAM-600 and SIPOMER PAM-4000 all available from Solvay; phosphoalkoxy (meth)acrylates such as phospho ethylene glycol (meth)acrylate, phospho diethylene glycol (meth)acrylate, phospho tri-ethylene glycol (meth)acrylate, phospho propylene glycol (meth)acrylate, phospho di-propylene glycol (meth)acrylate, phospho tri-propylene glycol (meth)acrylate, salts thereof, and mixtures thereof. Preferred phosphorus-containing acid monomers and salts thereof are selected from the group consisting of phosphoethyl (meth)acrylate, phosphopropyl (meth)acrylate, phosphobutyl (meth)acrylate, allyl ether phosphate, salts thereof, or mixtures thereof; more preferably, phosphoethyl methacrylate (PEM). The sulfonic acid monomers and salts thereof may include sodium vinyl sulfonate (SVS), sodium styrene sulfonate (SSS), acrylamido-methyl-propane sulfonate (AMPS), or mixtures thereof. The oligomer may comprise, by weight based on the weight of the oligomer, structural units of the acid monomer, the salt thereof or mixtures thereof, in an amount of 1% or more, 2% or more, 3% or more, 4% or more, 5% or more, 6% or more, 7% or more, 8% or more, 9% or more, or even 10% or more, and at the same time, 20% or less, 18% or less, 17% or less, 16% or less, 15% or less, 14% or less, 10% or less, or even 5% or less.

The oligomer useful in the present invention may also comprise structural units of one or more monoethylenically unsaturated functional monomers carrying at least one of functional groups selected from an amide, acetoacetate, carbonyl, ureido, silane, hydroxy, or amino group, or combinations thereof. Suitable monoethylenically unsaturated functional monomers may include, for example, amino-functional monomers such as dimethylaminoethyl methacrylate, dimethylaminoethyl acrylate, dimethylaminopropyl methacrylate, dimethylaminopropyl acrylate; monomers bearing acetoacetate-functional groups such as acetoacetoxyethyl methacrylate (AAEM), acetoacetoxyethyl acrylate, acetoacetoxypropyl methacrylate, acetoacetoxypropyl acrylate, allyl acetoacetate, acetoacetoxybutyl methacrylate, acetoacetoxybutyl methacrylate, acetoacetamidoethyl methacrylate, acetoacetamidoethyl acrylate; monomers bearing carbonyl-containing groups such as diacetone acrylamide (DAAM), diacetone methacrylamide; monomers bearing amide-functional groups such as acrylamide and methacrylamide; vinyltrialkoxysilanes such as vinyltrimethoxysilane, vinyltriethoxysilane, vinyltris(2-methoxyethoxy)silane, vinyldimethylethoxysilane vinylmethyldiethoxysilane or (meth)acryloxyalkyltrialkoxysilanes such as (meth)acryloxyethyltrimethoxysilane and (meth)acryloxypropyltrimethoxysilane; hydroxy-functional alkyl (meth)acrylates such as 2-hydroxyethyl (meth)acrylate and hydroxypropyl (meth)acrylate; or mixtures thereof. The monoethylenically unsaturated functional monomer may comprise diacetone acrylamide (DAAM). The oligomer may comprise, by weight based on the weight of the oligomer, from zero to 20% of structural units of the monoethylenically unsaturated functional monomer, for example, 0.1% or more, 0.5% or more, 1% or more, 1.5% or more, or even 2% or more, and at the same time, 20% or less, 18% or less, 16% or less, 15% or less, or even 14% or less.

The oligomer useful in the present invention may optionally comprise structural units of one or more hydrophobic monoethylenically unsaturated nonionic monomers that are different from the monomers described above. “Nonionic monomers” herein refers to monomers that do not bear an ionic charge between pH=1-14. “Hydrophobic” monomer in the present invention refers to a monomer having a calculated Hansch parameter≥2.

As used herein, the term “calculated Hansch parameter” for any molecule refers to parameters representing an index of polymer hydrophobicity, with higher values indicating greater hydrophobicity, as calculated according to the Kowwin methodology. A tool for this can be downloaded at https://www.epa.gov/tsca-screening-tools/epi-suitetm-estimation-program-interface. The Kowwin methodology uses a corrected “fragment constant” methodology to predict the Hansch parameter, expressed as log P. For any molecule, the molecular structure is divided into fragments each having a coefficient and all coefficient values in the structure are summed together to yield the log P estimate for the molecule. Fragments can be atoms but are larger functional groups (e.g. C═O) if the groups give a reproducible coefficient. The coefficients for each individual fragment were derived by multiple regression of reliably measured log P values (KOWWIN's “reductionist” fragment constant methodology), wherein the log P is measured by testing the fragment in a mixture of water and a given hydrophobic organic solvent. In the corrected fragment constant methodology, the coefficients of groups are adjusted by a correction factor to account for any differences between a measured log P coefficient value of a group and a log P for the same group that would result from summing the estimated log P coefficients from all atoms in the group alone. The KOWWIN calculation tool and estimation methodology were developed at Syracuse Research Corporation. A journal article by Meylan and Howard (1995) describes the program methodology as the “Atom/fragment contribution method for estimating octanol-water partition coefficients.” J. Pharm. Sci. 1995, 84, 83-92. Hansch parameters can be calculated from coefficient values found at the website listed. Hansch parameters for common vinyl monomers are available from “Exploring QSAR: Volume 2: Hydrophobic, Electronic and Steric Constants”, Hansch, C., Leo, A., Hoekman, D., 1995, American Chemical Society, Washington, D.C. Hansch values of some commonly used monomers are as follows, 0.99 (methacrylic acid), 0.44 (acrylic acid), 1.28 (methyl methacrylate), 2.20 (butyl acrylate), −0.05 (diacetone acrylamide), 4.64 (2-ethylhexyl acrylate), 2.89 (styrene), 0.22 (phosphoethyl methacrylate), 2.75 (Butyl methacrylate), 0.24 (acetoacetoxyethyl methacrylate), 0.73 (methyl acrylate), and 6.68 (lauryl methacrylate).

The hydrophobic monoethylenically unsaturated nonionic monomers useful in the present invention may include vinyl aromatic monomers such as styrene and substituted styrene, C₄-C₂₀-alkyl esters of (meth)acrylic acid such as butyl (meth)acrylate, 2-ethylhexyl (meth)acrylate, lauryl (meth)acrylate, stearyl (meth)acrylate, or mixtures thereof. The oligomer may comprise, by weight based on the weight of the oligomer, structural units of the hydrophobic monoethylenically unsaturated nonionic monomer, in an amount of from zero to 30%, for example, 28% or less, 25% or less, 20% or less, 10% or less, 5% or less, or even 1% or less.

The oligomer useful in the present invention may further comprise structural units of one or more hydrophilic monoethylenically unsaturated nonionic monomers that are different from the monomers described above. “Hydrophilic” monomer in the present invention refers to a monomer with a calculated Hansch parameter less than 2.2 (<2.2). The hydrophilic monoethylenically unsaturated nonionic monomers may include C₁-C₃-alkyl esters of (meth)acrylic acid, and preferably, C₁-C₂-alkyl esters of (meth)acrylic acid. Examples of suitable hydrophilic monoethylenically unsaturated nonionic monomers include methyl (meth)acrylate, ethyl (meth)acrylate, or mixtures thereof, and preferably, methyl methacrylate, ethyl acrylate, or mixtures thereof. The oligomer may comprise, by weight based on the weight of the oligomer, structural units of the hydrophilic monoethylenically unsaturated nonionic monomer in an amount of 30% or more, 40% or more, 50% or more, 55% or more, 60% or more, 65% or more, or even 70% or more, and at the same time, 99% or less, 98% or less, 95% or less, 93% or less, 92% or less, 90% or less, or even 88% or less.

The oligomer useful in the present invention may comprise, by weight based on the weight of the oligomer, from 7% to 15% of structural units of the acid monomer, the salt thereof, or mixtures thereof, from 70% to 93% of structural units of the hydrophilic monoethylenically unsaturated monomer, from 0 to 5% of structural units of the monoethylenically unsaturated functional monomer, and from 0 to 10% of structural units of the hydrophobic monoethylenically unsaturated monomer.

The oligomer useful in the present invention may have a number average molecular weight (Mn) of 1,000 g/mol or more, 2,000 g/mol or more, 3,000 g/mol or more, 3,500 g/mol or more, 4,000 g/mol or more, 4,500 g/mol or more or even 5,000 g/mol or more, and at the same time, 9,500 g/mol or less, 9,000 g/mol or less, 8,500 g/mol or less, 8,000 g/mol or less, 7,800 g/mol or less, 7,500 g/mol or less, 7,300 g/mol or less, or even 7,000 g/mol or less. Mn may be determined by gel permeation chromatography (GPC) analysis using a polystyrene standard.

The oligomer in the aqueous coating composition of the present invention may be present, by weight based on the weight of the film-forming polymer described below, in an amount of 9.5% or more, 10% or more, 10.5% or more, 11% or more, 12% or more, 13% or more, 14% or more, or even 15% or more, and at the same time, 85% or less, 80% or less, 75% or less, 70% or less, 65% or less, 60% or less, 55% or less, 50% or less, 45% or less, 40% or less, 35% or less, or even 30% or less.

The process of preparing the oligomer useful in the present invention may be conducted by free-radical polymerization, such as suspension polymerization, solution polymerization or emulsion polymerization, of the monomers described above. Emulsion polymerization is a preferred process. Total concentration of structural units of the oligomer is equal to 100%. Total weight concentration of monomers for preparing the oligomer is equal to 100%. A mixture of monomers for preparing the oligomer may be added neat or as an emulsion in water; or added in one or more additions or continuously, linearly or nonlinearly, over the reaction period of preparing the oligomer, or combinations thereof. Temperature suitable for emulsion polymerization processes may be lower than 100° C., in the range of from 30 to 95° C., or in the range of from 50 to 90° C. Multistage free-radical polymerization using the monomers described above can be used, which at least two stages are formed sequentially, and usually results in the formation of the multistage polymer comprising at least two polymer compositions.

In the polymerization process of preparing the oligomer, free radical initiators may be used. The polymerization process may be thermally initiated or redox initiated emulsion polymerization. Examples of suitable free radical initiators include hydrogen peroxide, t-butyl hydroperoxide, cumene hydroperoxide, ammonium and/or alkali metal persulfates, sodium perborate, perphosphoric acid, and salts thereof; potassium permanganate, and ammonium or alkali metal salts of peroxydisulfuric acid. The free radical initiators may be used typically at a level of 0.01 to 3.0% by weight, based on the total weight of monomers. Redox systems comprising the above described initiators coupled with a suitable reductant may be used in the polymerization process. Examples of suitable reductants include sodium sulfoxylate formaldehyde, ascorbic acid, isoascorbic acid, alkali metal and ammonium salts of sulfur-containing acids, such as sodium sulfite, bisulfite, thiosulfate, hydrosulfite, sulfide, hydrosulfide or dithionite, formadinesulfinic acid, acetone bisulfite, glycolic acid, hydroxymethanesulfonic acid, glyoxylic acid hydrate, lactic acid, glyceric acid, malic acid, tartaric acid and salts of the preceding acids. Metal salts of iron, copper, manganese, silver, platinum, vanadium, nickel, chromium, palladium, or cobalt may be used to catalyze the redox reaction. Chelating agents for the metals may optionally be used.

In the polymerization process of preparing the oligomer, a surfactant may be used. The surfactant may be added prior to or during the polymerization of the monomers, or combinations thereof. A portion of the surfactant can also be added after the polymerization. These surfactants may include anionic and/or nonionic emulsifiers. Examples of suitable surfactants include alkali metal or ammonium salts of alkyl, aryl, or alkylaryl sulfates, sulfonates or phosphates; alkyl sulfonic acids; sulfosuccinate salts; fatty acids; ethylenically unsaturated surfactant monomers; and ethoxylated alcohols or phenols. In some preferred embodiments, the alkali metal or ammonium salts of alkyl, aryl, or alkylaryl sulfates surfactant are used. The surfactant used is usually in an amount of from 0.1% to 6% or from 0.3% to 1.5%, by weight based on the weight of total monomers used for preparing the oligomer.

In the polymerization process of preparing the oligomer, a train transfer agent may be used. Examples of suitable chain transfer agents include 3-mercaptopropionic acid, dodecyl mercaptan, methyl 3-mercaptopropionate, butyl 3-mercaptopropionate, benzenethiol, azelaic alkyl mercaptan, or mixtures thereof. The chain transfer agent may be used in an effective amount to control the molecular weight of the oligomer. For example, the chain transfer agent may be used in preparing the oligomer in an amount of from 0.3% to 10% by weight based on the total weight of monomers used for preparing the oligomer.

After completing the polymerization of the oligomer, the obtained oligomer may be controlled to a pH value of at least 6, for example, from 6 to 11, or from 7 to 10, by neutralization. Neutralization may be conducted by adding one or more bases which may lead to partial or complete neutralization of the ionic or latently ionic groups of the multistage polymeric particles. Examples of suitable bases include ammonia; alkali metal or alkaline earth metal compounds such as sodium hydroxide, potassium hydroxide, calcium hydroxide, zinc oxide, magnesium oxide, sodium carbonate; primary, secondary, and tertiary amines, such as triethyl amine, ethylamine, propylamine, monoisopropylamine, monobutylamine, hexylamine, ethanolamine, diethyl amine, dimethyl amine, di-n-propylamine, tributylamine, triethanolamine, dimethoxyethylamine, 2-ethoxyethylamine, 3-ethoxypropylamine, dimethylethanolamine, diisopropanolamine, morpholine, ethylenediamine, 2-diethylaminoethylamine, 2,3-diaminopropane, 1,2-propylenediamine, neopentanediamine, dimethylaminopropylamine, hexamethylenediamine, 4,9-dioxadodecane-1,12-diamine, polyethyleneimine or polyvinylamine; aluminum hydroxide; or mixtures thereof.

The aqueous coating composition of the present invention also comprises one or more film-forming polymers (also known as “binder”), typically in the form of an emulsion or an aqueous dispersion. “Film-forming polymer” herein refers to a polymer having higher number average molecular weight than the oligomer described above. The film-forming polymer useful in the present invention may have a number average molecular weight (Mn) of 10,000 g/mol or more, 30,000 g/mol or more, 60,000 g/mol or more, 80,000 g/mol or more, 100,000 g/mol or more, or even 200,000 g/mol or more. Mn may be determined by GPC analysis using a polystyrene standard. The film-forming polymer particles may have a particle size of from 30 nanometers (nm) to 500 nm, from 70 nm to 300 nm, or from 70 nm to 250 nm. Particle size of the film-forming polymer is determined by Brookhaven BI-90 Plus Particle Size Analyzer.

The film-forming polymer in the aqueous coating composition of the present invention may be selected from an acrylic polymer including an acrylic copolymer and a styrene-acrylic copolymer, a polyurethane, a polyurethane-acrylic hybrid polymer, or mixtures thereof. The acrylic polymer useful in the present invention, typically an emulsion polymer, may comprise structural units of one or more monoethylenically unsaturated nonionic monomers. Suitable monoethylenically unsaturated nonionic monomers herein may include those hydrophilic and hydrophobic monoethylenically unsaturated nonionic monomers described in the oligomer section above. The acrylic polymer may comprise, by weight based on the weight of the acrylic polymer, from 75% to 90% or from 80% to 85% of structural units of the monoethylenically unsaturated nonionic monomer. The acrylic polymer may also comprise structural units of one or more acid monomers, salts thereof, or mixtures thereof. Suitable acid monomers and salts thereof herein may include those described in the oligomer section above. The acrylic polymer may comprise, by weight based on the weight of the acrylic polymer, from zero to 15% of structural units of the acid monomer, the salt thereof or mixtures thereof, for example, from 0.1% to 10%, from 0.5% to 8%, from 1% to 6%, from 1.5% to 5%, or from 2% to 4%. The acrylic polymer may further comprise structural units of one or more multiethylenically unsaturated monomers including di-, tri-, tetra-, or higher multifunctional ethylenically unsaturated monomers. Examples of suitable multiethylenically unsaturated monomers include butadiene, allyl (meth)acrylate, divinyl benzene, ethylene glycol dimethacrylate, butylene glycol dimethacrylate, or mixtures thereof. The acrylic polymer may comprise, by weight based on the weight of the acrylic polymer, from 0 to 5%, from 0.1% to 3%, or from 0.5% to 1.5% of structural units of the multiethylenically unsaturated monomer. The acrylic polymer useful in the present invention may have a T_{g} of from 0 to 120° C., or from 10 to 100° C. or from 20 to 80° C. as measured by differential scanning calorimetry (DSC) according to the test method described in the Examples section below. The polyurethane useful in the present invention, typically present in an aqueous dispersion, may be a reaction product of one or more polyols with one or more isocyanate compounds. “Polyols” refers to any products having two or more hydroxyl groups per molecule. Polyols useful in preparing the polyurethane may include polyether diols, polyester diols, polycarbonate polyols, multi-functional polyols, or mixtures thereof. The polyols may be selected from polyether polyols, polyester polyols, polycarbonate polyols, or mixtures thereof. The polyester polyols useful in preparing the polyurethane are typically esterification products prepared by the reaction of organic polycarboxylic acids or their anhydrides with a stoichiometric excess of a diol(s). Examples of suitable polyester polyols useful in preparing the polyurethane include poly(glycol adipate), poly(ethylene terephthalate) polyols, polycaprolactone polyols, alkyd polyols, orthophthalic polyols, sulfonated and phosphonated polyols, and the mixture thereof. The diols useful in preparing the polyester polyols include those described above for preparing the polyether polyols. Suitable carboxylic acids useful in preparing the polyester polyols may include dicarboxylic acids, tricarboxylic acids and anhydrides, such as maleic acid, maleic anhydride, succinic acid, glutaric acid, glutaric anhydride, adipic acid, suberic acid, pimelic acid, azelaic acid, sebacic acid, chlorendic acid, 1,2,4-butane-tricarboxylic acid, phthalic acid, the isomers of phthalic acid, phthalic anhydride, fumaric acid, dimeric fatty acids such as oleic acid, and the like, or mixtures thereof. Preferred polycarboxylic acids useful in preparing the polyester polyols include aliphatic and aromatic dibasic acids. The isocyanate compounds useful in preparing the polyurethane have two or more isocyanate groups on average, preferably two to three isocyanate groups per molecule. The isocyanate compounds typically comprise 5 to 20 carbon atoms and include aliphatic, cycloaliphatic, aryl-aliphatic, and aromatic polyisocyanates, oligomers thereof, or mixtures thereof.

The aqueous dispersion of the film-forming polymer useful in the present invention may have a minimum film formation temperature (MFFT) in the range of from 0 to 70° C., from 10 to 60° C., or from 20 to 55° C., as determined according to ASTM D 2354-10 (2018).

The aqueous coating composition of the present invention may comprise, by weight based on the weight of the aqueous coating composition, the film-forming polymer in an amount of 12.5% or more, 15% or more, 20% or more, 30% or more, 40% or more, 50% or more, or even 65% or more, and at the same time, 87% or less, 85% or less, 80% or less, 75% or less, or even 70% or less.

The aqueous coating composition of the present invention may further comprise one or more beads. “Beads” herein refers to polymeric or inorganic particles having a mean particle size of 1 μm or more. Suitable beads useful in the present invention may have a mean particle size of 5.0 μm or more, 5.2 μm or more, 5.5 μm or more, 5.8 μm or more, 6.0 μm or more, 6.2 μm or more, 6.5 μm or more, 7 μm or more, or even 7.5 μm or more, and at the same time, 10.5 μm or less, 10.2 μm or less, 10 μm or less, 9.8 μm or less, 9.5 μm or less, 9.2 μm or less, or even 9.0 μm or less. Mean particle size of beads herein refers to d50 particle size as determined according to ISO-13320-1. The beads useful in the present invention may be supplied as powder or in the form of a dispersion or suspension. The beads may comprise crosslinked or uncrosslinked polyacrylic beads including poly(methyl methacrylate) beads, silicone rubber beads, polyurethane beads such as crosslinked polyurethane, inorganic beads such as silica beads, or mixtures thereof.

The polyacrylic beads useful in the present invention may be formed by methods known in the art such as, for example, emulsion polymerization as described above, seeded growth process, or suspension polymerization process, preferably seeded growth process such as those described in U.S. Pat. No. 4,530,956. Such polymeric beads are described, for example, in U.S. Pat. Nos. 4,403,003, 7,768,602, and 7,829,626. The aqueous dispersion of polymeric beads may be prepared by a process comprising the step of contacting, under polymerization conditions, an aqueous dispersion of first microspheres with first stage monomers to grow out the first microspheres to form the aqueous dispersion of polymeric beads.

The silicone rubber beads useful in the present invention may be prepared by condensation product of a crosslinkable silicone composition comprising, essentially consists of, or consists of components (a) to (c). Component (a) useful for forming the silicone rubber beads is the main or base component of condensation reaction taken place to create silicone rubber powder in suspension. Component (a) may comprise one or more organosiloxanes having at least two silicone atom-bonded hydroxyl groups in a molecule. The silicone atom-bonded hydroxyl groups in component (a) are preferably present in the molecular chain terminal positions. Silicon atom-bonded organic groups in component (a) can be exemplified by substituted and unsubstituted monovalent hydrocarbyl groups among which are alkyl groups such as methyl, ethyl, propyl, and butyl; alkenyl groups such as vinyl and aliyl; aryl groups such as phenyl; aralkyl groups such as benzyl and phenethyl; cycloalkyl groups such as cyclopentyl and cyclohexyl; and halogenated alkyl groups such as 3-chloropropyl and 3,3,3-trifluoropropyl. Preferably, the organosiloxane comprises polydimethylsiloxane.

Component (b) useful for forming the silicone rubber beads is an organoalkoxysilane or partially hydrolysate thereof which functions to crosslink crosslinkable silicone composition condensing with hydroxyl groups in component (a). Component (b) may contain at least three silicon atom-bonded hydrogen atoms in each molecule. The silicon atom-bonded hydrolyzable groups in component (b) may contain methoxy, ethoxy, or methoxyethoxy groups. Such examples may include methyltrimethoxysilane, ethyltrimethoxysilane, methyl tris(methoxyethoxy) silane, tetramethoxysilane, and tetraethoxysilane, and the partial hydrolysis and condensation products of these alkoxy silanes or mixtures thereof; polymethoxy siloxane tetra-n-propoxysilane, pentyltrimethoxy silane, hexyltrimethoxy silane, and octyltrimethoxysilane; (meth)acryl functional alkoxysilanes such as 3-methacryloxypropyltrimethoxysilane, 3-methacryloxypropylmethyldimethoxysilane, and 3-methacryloxypropyldimethylmethoxysilane; epoxy functional alkoxysilanes among which are compositions such as 3-glycidoxypropyltrimethoxy silane, 3-glycidoxypropylmethyl dimethoxysilane, 2-(3,4-epoxycyclohexyl) ethyl trimethoxy silane, 2-(3,4-epoxycyclohexyl) ethylmethyl dimethoxysilane, 4-oxiranylbutyitrirnethoxy silane, 4-oxiranylbutyitriethoxysilane, 4-oxiranyibutylmethyldimethoxy silane, 8-oxiranyioctyitrimethoxysilane, 8-oxiranyloctyltriethoxysilane, and 8-oxiranyloctylmethyidimethoxy silane; mercapto functional alkoxysilanes such as 3-mercaptopropyltrimethoxy silane and 3-mercaptopropylmethyidimethoxy silane; amino functional alkoxysilanes such as 3-aminopropyltrimethoxy silane, N-(2-aminoethyl)-3-aminopropyltrimethoxysilane, N-(2-aminoethyl)-3-aminopropyimethyl dimethoxysilane, 3-anilinopropyltrimethoxysilane, or mixtures thereof. The partial hydrolysis and condensation products of any of these compounds can also be employed.

Component (c) useful for forming the silicone rubber beads is an alkyl silicate that functions to crosslink the crosslinkable silicone composition and/or reinforce crosslinked silicone compositions, thereby creating appropriate three-dimensional crosslinking structure. The general formulae of the component (c) may be SiₙOₙ₋₁(OR)₂₍ₙ₊₁₎, wherein n is an integer of more than 1 to 100 and each R is independently an alkyl group. R may be an alkyl group containing 1 to 12 carbon atoms or from 1 to 6 carbon atoms, such as methyl, ethyl, propyl, butyl, hexyl, octyl, and decyl. For example, n may be 2 or more, 3 or more, 4 or more, or even 5 or more, and at the same time, 80 or less, 60 or less, 50 or less, 40 or less, 30 or less, 20 or less, 15 or less, or 10 or less. Specific examples of alkyl silicates include ethyl silicate. The silicone rubber beads can be crosslinked silicone rubber which is the reaction product of 100 parts by mass of the component (a), 3.0-10.0 parts by mass of component (b), and 2.0-10 parts by mass of the component (c). The silicone rubber particles may contain one or more epoxy functionality.

The aqueous coating composition of the present invention may comprise, by weight based on the weight of the film-forming polymer, the beads in an amount of 2.5% or more, 2.8% or more, 3% or more, 3.2% or more, 3.5% or more, 4% or more, 4.5% or more, or even 5% or more, and at the same time, 50% or less, 40% or less, 30% or less, 25% or less, 20% or less, 18% or less, 15% or less, 12% or less, or even 10% or less.

The aqueous coating composition of the present invention may further comprise a polyfunctional carboxylic hydrazide containing at least two hydrazide groups per molecule. The polyfunctional carboxylic hydrazides may act as a crosslinker and may be selected from adipic dihydrazide, oxalic dihydrazide, isophthalic dihydrazide, polyacrylic polyhydrazide, or mixtures thereof. The concentration of the polyfunctional carboxylic hydrazide may be from 0.5% to 10%, from 1% to 8%, or from 1.5% to 6%, by weight based on the weight of the oligomer.

The aqueous coating composition of the present invention may also comprise one or more pigments. Pigments may include particulate inorganic materials which are capable of materially contributing to the opacity or hiding capability of a coating. Such materials typically have a refractive index greater than 1.8. Examples of suitable pigments include titanium dioxide (TiO₂), zinc oxide, zinc sulfide, iron oxide, barium sulfate, barium carbonate, or mixtures thereof. The aqueous coating composition may also comprise one or more extenders. Extenders may include particulate inorganic materials typically having a refractive index of less than or equal to 1.8 and greater than 1.5. Examples of suitable extenders include calcium carbonate, aluminum oxide (Al₂O₃), clay, calcium sulfate, aluminosilicate, silicate, zeolite, mica, diatomaceous earth, solid or hollow glass, ceramic bead, and opaque polymers such as ROPAQUE™ Ultra E available from The Dow Chemical Company (ROPAQUE is a trademark of The Dow Chemical Company), or mixtures thereof. Pigments and extenders useful in the present invention typically have d50 particle size smaller than the beads described above, for example, from 0.1 to 4 μm, from 0.1 to 2 μm, from 0.1 to 1 μm, from 0.3 to 0.6 μm. The pigments and/or extenders may be present, by weight based on the total weight of the aqueous coating composition, in an amount of from 0 to 40%, from 5% to 30%, from 10% to 25%, or from 15% to 20%.

The aqueous coating composition of the present invention may further comprise one or more defoamers. “Defoamers” herein refers to chemical additives that reduce and hinder the formation of foam. Defoamers may be silicone-based defoamers, mineral oil-based defoamers, ethylene oxide/propylene oxide-based defoamers, alkyl polyacrylates, or mixtures thereof. The defoamer may be present, by weight based on the total weight of the aqueous coating composition, in an amount of from 0 to 2%, from 0.01% to 1.5%, or from 0.1% to 1%.

The aqueous coating composition of the present invention may further comprise one or more thickeners (also known as “rheology modifiers”). The thickeners may include polyvinyl alcohol (PVA), clay materials, acid derivatives, acid copolymers, urethane associate thickeners (UAT), polyether urea polyurethanes (PEUPU), polyether polyurethanes (PEPU), or mixtures thereof. Examples of suitable thickeners include alkali swellable emulsions (ASE) such as sodium or ammonium neutralized acrylic acid polymers; hydrophobically modified alkali swellable emulsions (HASE) such as hydrophobically modified acrylic acid copolymers; associative thickeners such as hydrophobically modified ethoxylated urethanes (HEUR); and cellulosic thickeners such as methyl cellulose ethers, hydroxymethyl cellulose (HMC), hydroxyethyl cellulose (HEC), hydrophobically-modified hydroxy ethyl cellulose (HMHEC), sodium carboxymethyl cellulose (SCMC), sodium carboxymethyl 2-hydroxyethyl cellulose, 2-hydroxypropyl methyl cellulose, 2-hydroxyethyl methyl cellulose, 2-hydroxybutyl methyl cellulose, 2-hydroxyethyl ethyl cellulose, and 2-hydoxypropyl cellulose. Preferred thickener is based on HEUR. The thickener may be present, by weight based on the total weight of the aqueous coating composition, in an amount of from 0 to 5%, from 0.01% to 4%, from 0.1% to 3%.

The aqueous coating composition of the present invention may further comprise one or more wetting agents. “Wetting agents” herein refer to chemical additives that reduce the surface tension of a coating composition, causing the aqueous coating composition to more easily spread across or penetrate the surface of a substrate. Wetting agents may be polycarboxylates, anionic, zwitterionic, or non-ionic. The wetting agent may be present, by weight based on the total weight of the aqueous coating composition, in an amount of from 0 to 5%, from 0.01% to 4%, from 0.1% to 3%.

The aqueous coating composition of the present invention may further comprise one or more coalescents. “Coalescents” herein refer to slow-evaporating solvents that fuse polymer particles into a continuous film under ambient condition. Examples of suitable coalescents include 2-n-butoxyethanol, dipropylene glycol n-butyl ether, propylene glycol n-butyl ether, dipropylene glycol methyl ether, propylene glycol methyl ether, propylene glycol n-propyl ether, diethylene glycol monobutyl ether, ethylene glycol monobutyl ether, ethylene glycol monohexyl ether, triethylene glycol monobutyl ether, dipropylene glycol n-propyl ether, n-butyl ether, or mixtures thereof. Preferred coalescents include dipropylene glycol n-butyl ether, ethylene glycol monobutyl ether, diethylene glycol monobutyl ether, n-butyl ether, or mixtures thereof. The coalescents may be present, by weight based on the total weight of the aqueous coating composition, in an amount of from 0 to 12%, from 0.1% to 10%, from 1% to 9%.

The aqueous coating composition of the present invention may further comprise water, for example, in an amount of from 30% to 90%, from 40% to 85%, or from 50% to 80%, by weight based on the total weight of the aqueous coating composition.

In addition to the components described above, the aqueous coating composition of the present invention may further comprise any one or combination of the following additives: buffers, neutralizers, dispersants, humectants, biocides, anti-skinning agents, colorants, flowing agents, anti-oxidants, plasticizers, freeze/thaw additives, leveling agents, thixotropic agents, adhesion promoters, anti-scratch additives, and grind vehicles. These additives may be present in a combined amount of, from 0 to 5%, from 0.001% to 3%, or from 0.1% to 2%, by weight based on the total weight of the aqueous coating composition.

The aqueous coating composition of the present invention may be prepared with techniques known in the coating art, for example, by admixing the film-forming polymer, the oligomer, the beads with other optional components described above. Components in the aqueous coating composition may be mixed in any order to provide the aqueous coating composition of the present invention. Any of the above-mentioned optional components may also be added to the composition during or prior to the mixing to form the aqueous coating composition.

The aqueous coating composition of the present invention can be applied to a substrate by incumbent means including brushing, dipping, rolling and spraying. The aqueous coating composition is preferably applied by spraying. The standard spray techniques and equipment for spraying such as air-atomized spray, air spray, airless spray, high volume low pressure spray, and electrostatic spray such as electrostatic bell application, and either manual or automatic methods can be used. After the aqueous coating composition of the present invention has been applied to a substrate, the coating composition can dry, or allow to dry, to form a film (this is, coating) at room temperature (20-25° C.), or at an elevated temperature, for example, from 35° C. to 60° C. The aqueous coating composition of the present invention can be applied to, and adhered to, various substrates, particularly wood. The aqueous coating composition is particularly suitable as a primer for wood coatings, such as furniture coatings, joinery coatings, and floor coatings. The aqueous coating composition of the present invention can provide coating films obtained therefrom (i.e., the coatings after drying, or allowing to dry, the aqueous coating composition applied to a substrate) with good anti-grain raising property on a wood substrate such as xylosma or rubberwood substrate. The coatings on the wood substrate typically have two layers with a total dry film thickness of 50-60 μm. “Good anti-grain raising property” or “improved anti-grain raising property” in the present invention refers to an anti-grain raising level of at least 4. The coatings may also show good sandability with a rating of 3 or more and preferably 4 or more. These properties may be measured according to the test methods described in the Examples section below.

The present invention also provides a method of preparing a coating. The method may comprise: forming the aqueous coating composition of the present invention, applying the aqueous coating composition to a substrate, and drying, or allowing to dry, the applied coating composition to form the coating. The aqueous coating composition can be used alone, or in combination with other coatings to form multi-layer coatings.

The present invention also provides a method of suppressing grain raising on a wood substrate subsequently coated with an aqueous top coating composition, comprising: applying the aqueous coating composition of the present invention to the wood substrate and drying the applied aqueous coating composition, prior to application of the aqueous top coating composition. The aqueous coating composition of the present invention is useful as a primer composition forming a primer coating. The aqueous top coating composition useful in the method is typically any conventional top coating composition that is different from the aqueous coating composition of the present invention. The aqueous top coating composition may comprise the film-forming polymer described above as a binder, including, for example, ROSHIELD™ 3311 acrylic polymer emulsion from The Dow Chemical Company (ROSHIELD is a trademark of The Dow Chemical Company). The method may further comprise drying the aqueous top coating to form a top coating with a dry film thickness of 30±5 μm. The method of suppressing grain raising of the present invention may comprise repeating the steps of applying and drying the aqueous coating composition of the present invention, prior to the application of the aqueous top coating composition. The aqueous coating composition of the present invention may form coatings with a total dry film thickness of 50-60 μm. The coated substrate obtained therefrom comprises a multi-layer coating with improved anti-grain raising property above.

### EXAMPLES

Some embodiments of the invention will now be described in the following Examples, wherein all parts and percentages are by weight unless otherwise specified. The following materials are used in the examples: Methyl methacrylate (MMA), butyl acrylate (BA), methacrylic acid (MAA), styrene (ST), methyl 3-mercaptopropanoate (MMP), ammonium persulfate (APS) and ammonia are all available from Sinoreagent Group.

Diacetone acrylamide (DAAM) is available from Kyowa Hakko Chemical Co., Ltd.

DISPONIL Fes-32, available from BASF, is a fatty alcohol ether sulphate, sodium salt.

BYK346, available from BYK, is a polyether-modified polysiloxane surfactant used as a wetting agent.

DOWANOL™ DPM coalescent (Dipropylene glycol methyl ether) and DOWANOL DPnB coalescent (Dipropylene glycol mono butyl ether) are both available from The Dow Chemical Company.

ACRYSOL™ RM-8W nonionic urethane rheology modifier and ACRYSOL RM-5000 nonionic urethane rheology modifier are available from The Dow Chemical Company.

ROSHIELD 3311 acrylic polymer emulsion (solids: 40%) (“RS3311”) is available from The Dow Chemical Company.

TEGO Airex 902 W polyether siloxane, available from Evonik, is used as a deformer.

PRIMAL™ BINDER U-91 emulsion, available from The Dow Chemical Company, is an aqueous dispersion of an aliphatic polyurethane (solids: 40%).

The following beads are used in the examples:

| | | Particle size* (μm) | | |
|---|---|---|---|---|
| Materials | Supplier | d10 | d50 | d90 |
| MRN-12H polymethyl methacrylate powder | Soken | 6.4 | 11.0 | 15.9 |
| MR-7HG polymethyl methacrylate powder | Soken | 1.2 | 6.2 | 10.4 |
| DOWSIL ™ IE 3301 elastomer suspension, a | The Dow Chemical | 2.6 | 9.4 | 19.1 |
| suspension of elastomeric silicone beads | Company | | | |
| containing epoxy functional groups suspended | | | | |
| in an aqueous anionic system (solids: 54%) | | | | |
| Aqueous dispersion of Beads A | Synthesis as below | 4.7 | 6.8 | 10.0 |
| OPTI-MATT ™ AB duller, a stabilized | The Dow Chemical | 1.0 | 4.8 | 8.7 |
| aqueous acrylic dulling agent (solids: 40%) | Company | | | |
| DAIPLACOAT RHU-5070D crosslinked | Dainichiseika Color & | 1.5 | 7.0 | 11.4 |
| polyurethane powder | Chemicals MFG. Co. Ltd. | | | |
| ACEMATT TS 100 untreated thermal silica | Evonik | — | 9.5 | — |

*Particle size was determined by ISO-13320-1 Particle size analysis - Laser diffraction methods by using Malvern Master Sizer-Hydro2000SM.

DOWANOL, ACRYSOL, DOWSIL, PRIMAL and OPTI-MATT are trademarks of The Dow Chemical Company.

The following standard analytical equipment and methods are used in the Examples.

### GPC Analysis

Molecular weight of a polymer or oligomer sample was measured by GPC analysis. The GPC analysis was performed generally by an Agilent 1200. The sample was dissolved in tetrahydrofuran (THF)/formic acid (FA) (5%) with a concentration of 2 mg/mL (milligram per milliliter) and then filtered through a 0.45 m polytetrafluoroethylene (PTFE) filter prior to GPC analysis. The GPC analysis was conducted using the following conditions:

Column: Two Mixed B columns (7.8 mm (millimeter)×300 mm) in tandem; column temperature: 35° C.; mobile phase: THF/FA (5%); flow rate: 1.0 mL/minute (min); Injection volume: 100 μL; detector: Agilent Refractive Index detector, 35° C.; and calibration curve: PL Polystyrene (PS) Narrow standards (Part No.: 2010-0101) with PS equivalent molecular weights ranging from 2329000 to 162 g/mol.

### DSC

A 5-10 mg sample was analyzed in a sealed aluminum pan on a TA Instrument DSC Q2000 fitted with an auto-sampler under nitrogen (N2) atmosphere. Tg measurement was conducted with three cycles including, from −50 to 200° C., 10° C./min (1^{st} cycle, then hold for 5 minutes to erase thermal history of the sample), from 200 to −50° C., 10° C./min (2^{nd} cycle), and from −50 to 200° C., 10° C./min (3^{rd} cycle). Tg was obtained from the 3^{rd} cycle by taking the mid-point in the heat flow versus temperature transition as the Tg value.

Mean Particle Size (d50)

Mean particle size (d50) was determined by ISO-13320-1 Particle size analysis—Laser diffraction methods by using Malvern Mastersizer-Hydro2000SM (Refractive index was set as 1.55).

### Anti-grain Raising Properties

A test coating composition sample was applied on rubberwood at 80-90 gram per square meter (g/m²) and then dried at room temperature for 2 hours, followed by sanding the resultant first coating. A second layer of the test coating composition was further applied to the first coating at 80-90 g/m² and then dried at room temperature for 2 hours to form the second coating. Then, a top coating composition ROSHIELD 3311 acrylic polymer emulsion was applied at 80-90 g/m² and dried at room temperature for another two hours. The resulting panel was touched and/or visual inspected, and then evaluated for anti-grain raising performance with ratings of 1-5 according to the area of grain raising:
5—<1% of the area with raised grain;
4—1%-5% of the area with raised grain;
3→5%-15% of area with raised grain;
2→15%-25% of the area with raised grain;
1→25% of the area with raised grain.
Anti-grain raising rating of 4 or higher is acceptable.

### Sandability

An aqueous coating composition to be tested was applied on rubberwood at 80-90 g/m² and dried at room temperature for 2 hours. The resultant coating was then sanded. Sandability means how easy to get a smooth surface when sanding a coating. Sandability was rated on a scale of 1-5, based on the shape of dust created by sanding:
5—Powder; 4—Powder to strip; 3—Strip; 2—Large aggregate; and 1—Not sandable.
Sandability rating of 3 or higher is acceptable.

### Preparation of Aqueous Dispersion of Beads A

An aqueous dispersion of acrylic oligomer seed (33% solids content, 67 butyl acrylate/18 n-dodecyl mercaptan/14.8 methyl methacrylate/0.2 methacrylic acid) was prepared as described in U.S. Pat. No. 9,155,549, from column 4, line 25 “A. Preparation of Pre-Seed” to column 5, line 20.

Initiator emulsion was prepared by combining in a separate vial deionized (DI) water (4.9 grams (g)), Rhodacal DS-4 branched alkylbenzene sulfonate from Solvay (DS-4, 0.21 g, 22.5% aq. solution), 4-hydroxy 2,2,6,6-tetramethylpiperidine (4-hydroxy TEMPO, 0.4 g, 5% solution), t-amyl peroxy-2-ethylhexanoate (TAPEH, 5.42 g, 98% active), then emulsified for 10 min with a homogenizer at 15000 rpm. The initiator emulsion was then added to the dispersion of the acrylic oligomer seed (4.2 g, 32% solids) in a separate vial and mixed for 60 min. A shot monomer emulsion (shot ME) was prepared in a separate flask by combining DI water (109.5 g), Solvay Sipomer PAM-200 phosphate esters of PPG monomethacrylate from Solvay (PAM-200, 1.3 g, 97% active), DS-4 (4.13 g, 22.5% solution), 4-hydroxy TEMPO (0.2 g, 5% solution), n-butyl acrylate (BA, 251.5 g) and allyl methacrylate (ALMA, 10.5 g). DI water (1575 g) was added to a 5-L round bottom flask (reactor) fitted with a stirrer, condenser, and a temperature probe. The reactor was heated to 70° C., after which time the initiator and oligomer seed mixture was added to the reactor, and shot ME was fed into the reactor over 15 min. After an induction period of 30 min, the resultant exotherm caused the reactor temperature to rise to 80° C.

A first monomer emulsion (ME1) prepared by combining DI water (328.5 g), PAM-200 (3.9 g), DS-4 (12.38 g, 22.5% solution), 4-hydroxy TEMPO (0.6 g, 5% solution), BA (754.5 g), and ALMA (31.5 g) was then fed into the reactor over 55 min. After a 20-min hold, NH₄OH (1.35 g, 28% aqueous solution) was fed into the reactor over 3 min.

The reactor temperature was cooled to and maintained at 75° C., after which time FeSO₄·7H₂O (11 g, 0.15% aqueous solution) and EDTA tetrasodium salt (2 g, 1% aqueous solution) were mixed and added to reactor. A second monomer emulsion (ME2) was prepared in a separate flask by combining DI water (90 g), DS-4 (3.2 g, 22.5% solution), methyl methacrylate (MMA, 254 g) and ethyl acrylate (EA, 10.9 g). ME2, t-butyl hydroperoxide solution (t-BHP, 1.44 g 70% aqueous solution in 100 g water) and isoascorbic acid (IAA, 1.44 g in 100 g water) was fed into the reactor over 45 min. The residual monomers were then chased by feeding t-BHP solution (2.54 g 70% aqueous solution in 40 g water) and IAA (1.28 g in 40 g water) into reactor over 20 min. The consequent dispersion was filtered through a 45 μm screen; gel that remained on the screen was collected and dried (270 ppm). The filtrate, i.e., aqueous dispersion of beads A, was analyzed for percent solids (42%).

### Preparation of Oligomer O1 Dispersion

Preparation of monomer emulsion: DISPONIL Fes-32 surfactant (38.55 g, 31% active) was dissolved in DI water (227 g) with stirring. Then monomers including MMA, MAA and DAAM, and MMP were slowly added into the resulting surfactant solution to obtain the monomer emulsion, based on dosages described in Table 1.

A solution containing DISPONIL Fes-32 surfactant (24.09 g, 31% active) and DI water (1587.70 g) was added into a 4-neck, 5-liter round bottom flask equipped with a thermocouple, a cooling condenser and an agitator, and was heated to 85° C. under a nitrogen atmosphere. An aqueous initiator solution of APS (3.91 g APS in 56.48 g DI water) and 4.0% by weight of the monomer emulsion obtained above were then added into the flask. Within 5 minutes (min), initiation of polymerization was confirmed by a temperature increase by 3° C. and a change of the external appearance of the reaction mixture. After heat generation stopped, an aqueous solution of Na₂CO₃ (1.66 g in 57.4 g DI water) was charged into reactor. And the remaining monomer emulsion was added gradually to the flask over a period of 40 min with stirring, and at the same time, an aqueous initiator solution of APS (1.64 g APS in 77.82 g DI water) was added gradually to the flask over a period of 50 min. And the temperature was maintained at 84-86° C. After the monomer emulsion and the initiator solution were consumed, the reaction mixture was held for 30 min. An aqueous ammonia solution (63.04 g, 25% active) was added into the reactor over 15 min and held for 20 min to dissolve or partially dissolve the resulting oligomer. Then DI water was added to adjust the solids to 27.3%.

### Preparation of Oligomer 02 Dispersion

Preparation of monomer emulsion: DISPONIL Fes-32 surfactant (26.02 g, 31% active) was dissolved in DI water (153.11 g) with stirring. Then monomers including MMA, MAA and DAAM, and MMP were slowly added into the resulting surfactant solution to obtain the monomer emulsion, based on dosages described in Table 1.

A solution containing DISPONIL Fes-32 surfactant (16.26 g, 31% active) and deionized water (900 g) was added into a 4-neck, 3-liter round bottom flask equipped with a thermocouple, a cooling condenser and an agitator, and was heated to 85° C. under a nitrogen atmosphere. An aqueous initiator solution of APS (2.64 g APS in 56.48 g DI water) and 4.0% by weight of the monomer emulsion obtained above were then added into the flask. Within 5 min, initiation of polymerization was confirmed by a temperature increase by 3° C. and a change of the external appearance of the reaction mixture. After heat generation stopped, an aqueous solution of Na₂CO₃ (1.12 g in 39 g DI water) was charged into reactor. And the remaining monomer emulsion was added gradually to the flask over a period of 40 min with stirring, and at the same time, an aqueous initiator solution of APS (1.70 g APS in 80 g DI water) was added gradually to the flask over a period of 50 min. And the temperature was maintained at 84-86° C. After the monomer emulsion and the initiator solution were consumed, the reaction mixture was held for 30 min. An aqueous ammonia solution (46 g, 25% active) was added into the reactor over 15 min and held for 20 min to dissolve or partially dissolve the resulting oligomer. Then DI water was added to adjust the solids.

### Preparation of Oligomers 03-05 Dispersions

The oligomers 03-05 dispersions were prepared according to the same procedure as preparation of the oligomer 02 dispersion, where ingredients used for preparing monomer emulsions are given in Table 1.

Properties of the obtained 01-05 dispersions above are summarized in Table 2.

TABLE 1
Ingredients used for preparing oligomer dispersions

| Oligomer | | | | | |
|---|---|---|---|---|---|
| dispersion | MMA (g) | DAAM (g) | MAA (g) | ST (g) | MMP (g) |
| O1 | 698.38 | 28.21 | 81.84 | 0 | 15.95 |
| O2 | 471.44 | 19.04 | 55.23 | 0 | 4.37 |
| O3 | 471.44 | 19.04 | 55.23 | 0 | 6.56 |
| O4 | 471.44 | 19.04 | 55.23 | 0 | 21.91 |
| O5 | 362.44 | 19.04 | 55.23 | 109.34 | 10.75 |

TABLE 2
Properties of oligomers

| Oligomer | | Solids | Particle | | |
|---|---|---|---|---|---|
| dispersion | pH | content¹ (%) | size² (nm) | Mn³ (g/mol) | Mw³ (g/mol) |
| O1 | 8.25 | 27.3 | 26 | 5480 | 12478 |
| O2 | 8.84 | 26.32 | 87 | 6674 | 20498 |
| O3 | 8.77 | 29.13 | 142 | 5608 | 15517 |
| O4 | 8.21 | 29.85 | 30 | 2797 | 5518 |
| O5 | 8.94 | 29.33 | 103 | 4239 | 10482 |

¹Solids content was measured by weighting 0.7 ± 0.1 g of a sample (wet weight of the sample is denoted as “W1”), putting the sample into an aluminum pan (weight of aluminum pan is denoted as “W2”) in an oven at 150° C. for 25 min, and then cooling and weighting the aluminum pan with the dried sample with total weight denoted as “W3”. “W3 − W2” refers to dry or solids weight of the sample. Solids content is calculated by (W3 − W2)/W1*100%.
²Particle size was measured by Brookhaven BI-90 Plus Particle Size Analyzer.
³Mn and Mw were measured by GPC analysis above.

### Coating Compositions of Examples (Exs) 1-20

A binder (RS3311 or U-91), the oligomer dispersions prepared above, beads, DOWANOL DPM coalescent, DPnB, BYK346 wetting agent (0.5 g), Tego Airex 902W defoamer (0.3 g), ACRYSOL RM-8W rheology modifier (0.5 g), ACRYSOL RM-5000 rheology modifier (0.5 g), and water were mixed and stirred at 600 rpm/min to give coating compositions of Exs 1-20, according to formulations given in Table 3. The loadings of the binder, the oligomer, and the beads used in each coating composition are given in Table 3. RS3311 emulsion was used as the binder in Exs 1-18 and 20, and U-91 emulsion was used as the binder in Ex 19. Water was used in an amount to make the total weight of each coating composition to 100 g. Solids content for each coating composition is also given in Table 3. The obtained coating compositions were evaluated according to the test methods described above and results of properties are given in Table 5.

TABLE 3
Coating Compositions of Exs 1-20

| | | | | | | | Beads | | | | | |
|---|---|---|---|---|---|---|---|---|---|---|---|---|
| | | Oligomer dispersion | | | | | | | Beads A | | | |
| gram | Binder | O1 | O2 | O3 | O4 | O5 | MR-7HG | IE3301 | dispersion | 5070D | TS-100 | Solids |
| Ex 1 | 65 | 13.5 | | | | | | 4.8 | | | | 0.32 |
| Ex 2 | 65 | 13.5 | | | | | 4.2 | | | | | 0.34 |
| Ex 3 | 65 | 13.5 | | | | | 10.4 | | | | | 0.35 |
| Ex 4 | 65 | 13.5 | | | | | | | 2.5 | | | 0.31 |
| Ex 5 | 65 | 13.5 | | | | | | 1.9 | | | | 0.31 |
| Ex 6 | 60 | 24.8 | | | | | | 1.8 | | | | 0.33 |
| Ex 7 | 60 | 27.3 | | | | | | 1.8 | | | | 0.33 |
| Ex 8 | 65 | 13.5 | | | | | | 0 | | 1.3 | | 0.31 |
| Ex 9 | 65 | 10.7 | | | | | | 1.9 | | | | 0.31 |
| Ex 10 | 65 | 17.9 | | | | | | 1.4 | | | | 0.32 |
| Ex 11 | 65 | 17.9 | | | | | | 7.2 | | | | 0.33 |
| Ex 12 | 60 | 16.5 | | | | | | 8.9 | | | | 0.34 |
| Ex 13 | 51 | 37.4 | | | | | | 1.9 | | | | 0.32 |
| Ex 14 | 41 | 45.2 | | | | | | 1.5 | | | | 0.31 |
| Ex 15 | 65 | | 17.9 | | | | | 7.2 | | | | 0.33 |
| Ex 16 | 65 | | | 17.9 | | | | 7.2 | | | | 0.33 |
| Ex 17 | 65 | | | | 17.9 | | | 7.2 | | | | 0.33 |
| Ex 18 | 65 | | | | | 17.9 | | 7.2 | | | | 0.33 |
| Ex 19 | 65 | 17.9 | | | | | | 4.8 | | | | 0.34 |
| Ex 20 | 65 | 13.4 | | | | | | | | | 1.5 | 0.31 |

### Coating Compositions of Comparative (Comp) Exs A-G

The coating compositions of Comp Exs A-G were prepared according to the same procedure as Ex 1, based on formulations given in Table 4. The obtained coating compositions were evaluated according to the test methods described above and results of properties are given in Table 5.

TABLE 4
Coating Compositions of Comp Exs A-G

| | Comp | Comp | Comp | Comp | Comp | Comp | Comp |
|---|---|---|---|---|---|---|---|
| gram | Ex A | Ex B | Ex C | Ex D | Ex E | Ex F | Ex G |
| RS3311 binder | 70 | 65 | 64 | 65 | 65 | 38 | 65 |
| O1 dispersion | | 13.4 | 26.5 | 13.4 | 9.0 | 50 | 17.9 |
| IE3301 | | | | | 2.4 | 1.7 | 1.0 |
| MRN-12H | | 2.6 | | | | | |
| AB duller | | | | 2.6 | | | |
| Beads A dispersion | 6.7 | | | | | | |
| DPM | 4 | 4 | 4 | 4 | 4 | 4 | 4 |
| DPnB | 3 | 3 | 3 | 3 | 3 | 3 | 3 |
| BYK346 | 0.5 | 0.5 | 0.5 | 0.5 | 0.5 | 0.5 | 0.5 |
| 902W | 0.3 | 0.3 | 0.3 | 0.3 | 0.3 | 0.3 | 0.3 |
| RM-8W | 0.5 | 0.5 | 0.5 | 0.5 | 0.5 | 0.5 | 0.5 |
| RM-5000 | 0.5 | 0.5 | 0.5 | 0.5 | 0.5 | 0.5 | 0.5 |
| Water | 14.5 | 10.2 | 0.7 | 10.2 | 14.8 | 1.4 | 7.3 |
| Total | 100 | 100 | 100 | 100 | 100 | 100 | 100 |
| Solids | 0.31 | 0.35 | 0.33 | 0.31 | 0.30 | 0.31 | 0.32 |

As shown in Table 5, the coating compositions of Exs 1-20 all provided coatings with both excellent anti-grain raising performance and good sandability. In contrast, the coating compositions of Comp Exs A-G all showed unsatisfactory anti-grain raising properties.

TABLE 5
Properties of Coating Compositions

| | Composition (binder, oligomer and | | |
|---|---|---|---|
| | beads), percentage by solids/dry | Anti-grain | |
| | weight based on the weight of the | raising | Sand- |
| Example | film-forming polymer binder) | level | ability |
| Ex 1 | RS3311 + 14% O1 + 10% IE 3301 | 4 | 4 |
| Ex 2 | RS3311 + 14% O1 + 4% MR-7HG | 4 | 4 |
| Ex 3 | RS3311 + 14% O1 + 10% MR-7HG | 4 | 4 |
| Ex 4 | RS3311 + 14% O1 + 4% Beads A | 4 | 4 |
| Ex 5 | RS3311 + 14% O1 + 4% IE3301 | 4 | 4 |
| Ex 6 | RS3311 + 28% O1 + 4% IE3301 | 4 | 4 |
| Ex 7 | RS3311 + 31% O1 + 4% IE3301 | 4 | 4 |
| Ex 8 | RS3311 + 14% O1 + 5% 5070D | 4 | 4 |
| Ex 9 | RS3311 + 11% O1 + 4% IE3301 | 4 | 4 |
| Ex 10 | RS3311 + 19% O1 + 3% IE3301 | 4 | 4 |
| Ex 11 | RS3311 + 19% O1 + 15% IE3301 | 4 | 4 |
| Ex 12 | RS3311 + 19% O1 + 20% IE3301 | 4 | 4 |
| Ex 13 | RS3311 + 50% O1 + 5% IE3301 | 4 | 4 |
| Ex 14 | RS3311 + 75% O1 + 5% IE3301 | 4 | 4 |
| Ex 15 | RS3311 + 18% O2 + 15% IE3301 | 4 | 4 |
| Ex 16 | RS3311 + 20% O3 + 15% IE3301 | 4 | 4 |
| Ex 17 | RS3311 + 20% O4 + 15% IE3301 | 4 | 4 |
| Ex 18 | RS3311 + 20% O5 + 15% IE3301 | 4 | 4 |
| Ex 19 | U-91 + 19% O1 + 10% IE3301 | 4 | 4 |
| Ex 20 | RS3311 + 14% O1 + 5% TS-100 | 4 | 4 |
| Comp Ex A | RS3311 + 10% Beads A | 2 | 4 |
| Comp Ex B | RS3311 + 14% O1 + 10% MZ-12H | 2 | 3 |
| Comp Ex C | RS3311 + 28% O1 | 2 | 3 |
| Comp Ex D | RS3311 + 14% O1 + 4% AB duller | 3 | 3 |
| Comp Ex E | RS3311 + 9% O1 + 5% IE3301 | 3 | 3 |
| Comp Ex F | RS3311 + 90% O1 + 5% IE3301 | 3 | 4 |
| Comp Ex G | RS3311 + 19% O1 + 2% IE3301 | 3 | 3 |

What is claimed is:

1. An aqueous coating composition, comprising:
(a) from 12.5% to 87% by weight based on the weight of the aqueous coating composition, of a film-forming polymer;
(b) from 9.5% to 85% by weight based on the weight of the film-forming polymer, of an oligomer having a number average molecular weight of 9,500 g/mol or less,
wherein the oligomer comprises, by weight based on the weight of the oligomer,
from 1% to 20% of structural units of an acid monomer, a salt thereof, or mixtures thereof,
from 30% to 99% of structural units of a hydrophilic monoethylenically unsaturated nonionic monomer,
from 0 to 30% of structural units of a hydrophobic monoethylenically unsaturated nonionic monomer, and
from 0 to 20% of structural units of a monoethylenically unsaturated functional monomer; and
(c) from 2.5% to 50% by weight based on the weight of the film-forming polymer, of beads with a mean particle size of from 5.0 to 10.5 μm.

2. The aqueous coating composition of claim 1, wherein the oligomer comprises, by weight based on the weight of the oligomer, from 6% to 18% of structural units of the acid monomer, the salt thereof, or mixtures thereof.

3. The aqueous coating composition of claim 1 wherein the hydrophilic monoethylenically unsaturated nonionic monomer is selected from methyl (meth)acrylate, ethyl (meth)acrylate, or mixtures thereof.

4. The aqueous coating composition of claim 1 comprising, by weight based on the weight of the film-forming polymer, from 11% to 70% of the oligomer.

5. The aqueous coating composition of claim 1 wherein the oligomer has a number average molecular weight of from 2,500 to 7,000 g/mol.

6. The aqueous coating composition of claim 1 wherein the oligomer comprises, by weight based on the weight of the oligomer, from 7% to 15% of structural units of the acid monomer, the salt thereof, or mixtures thereof, from 70% to 93% of structural units of the hydrophilic monoethylenically unsaturated monomer, from 0 to 10% of structural units of the hydrophobic monoethylenically unsaturated monomer, and from 0 to 5% of structural units of the monoethylenically unsaturated functional monomer.

7. The aqueous coating composition of claim 1, wherein the beads are polyacrylic beads, silicone rubber beads, polyurethane beads, or mixtures thereof.

8. The aqueous coating composition of claim 1, wherein the beads are silica beads.

9. The aqueous coating composition of claim 1, wherein the film-forming polymer is selected from the group consisting of an acrylic polymer, a polyurethane, or mixtures thereof.

10. The aqueous coating composition of claim 1, wherein the beads are present in an amount of from 4% to 30% by weight based on the weight of the film-forming polymer.

11. The aqueous coating composition a of claim 1, wherein the beads have a mean particle size of from 6.0 to 10 μm.

12. A process for preparing the aqueous coating composition of claim 1, comprising: admixing (a) from 12.5% to 87% by weight based on the weight of the aqueous coating composition, of a film-forming polymer; (b) from 9.5% to 85% by weight based on the weight of the film-forming polymer, of an oligomer having a number average molecular weight of 9,500 g/mol or less; and (c) from 2.5% to 50% by weight based on the weight of the film-forming polymer, of beads with a mean particle size of from 5.0 to 10.5 μm;
wherein the oligomer comprises, by weight based on the weight of the oligomer,
from 1% to 20% of structural units of an acid monomer, a salt thereof, or mixtures thereof,
from 30% to 99% of structural units of a hydrophilic monoethylenically unsaturated nonionic monomer,
from 0 to 30% of structural units of a hydrophobic monoethylenically unsaturated nonionic monomer, and
from 0 to 20% of structural units of a monoethylenically unsaturated functional monomer.
